(19) United States
(12) Patent Application Publication
(10) Pub. No.: US 2004/0205530 A1
(43) Pub. Date: Oct. 14, 2004

(54) System and method to automatically complete electronic forms

(76) Inventor: Michael J. Borg, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/892,701

(22) Filed: Jun. 28, 2001

(51) Int. Cl. G06F 15/00

(52) U.S. Cl. 715/507; 715/505

(57) ABSTRACT

The invention is a method, a computer readable medium, and a system for automated form completion for a user of a computer. In this regard, the method comprises the steps of identifying one or more fields in a form and automatically supplying information corresponding to the one or more identified fields without intervention by the user. The computer readable medium is capable of being embedded with a computer software configured to perform the above mentioned method. The system comprises a field identifier module capable of identifying one or more fields in a form and a field completer module capable of supplying information corresponding to the one or more identified fields without intervention by the user.

### FIELD OF THE INVENTION

This invention relates generally to document processing and more particularly to form filling.

### BACKGROUND OF THE INVENTION

It is generally known that many Web sites gather information from users wishing to utilize the resources of the Web site. For example, “cookies” allow Web sites to collect data about users' Web activities (e.g., Web pages visited, etc.). Additionally, Web sites often prefer to gather personal data (e.g., name, address, etc.). Web sites are thus generally equipped with a registration page. In this regard, a user may re-enter the same information many times at different Web site registration pages. Thus, filling out Web site registration pages may be frustrating to users.

However, different Web sites may wish to gather different types of personal data. Additionally, there may be no standard order of entry. For example, one Web site registration page may ask for home address then business address, while a second Web site registration page may ask for business address then home address. Moreover, there may be no standard naming convention for certain types of requested data. For example, different Web site registration pages may alternatively refer to last name as: surname, Christian name, or last name. Thus, filling out Web site registration pages may not be easily automated.

Previous methods of addressing this problem include MICROSOFT PASSPORT WALLET. In this regard, personal and credit card information is gathered from a user. Web sites participating in the MICROSOFT PASSPORT WALLET program receive all of the information entered by the user at the time the user requests to use the services of the participating Web site.

### SUMMARY OF THE INVENTION

The invention is a method, a computer readable medium, and a system of automated form completion.

In one respect, the invention is a method for automated form completion for a user of a computer. The method comprises the steps of identifying one or more fields in a form and automatically supplying information corresponding to the one or more identified fields without intervention by the user.

In another respect, the invention is a computer readable medium on which is embedded computer software capable of automatically completing a form for a user of a computer. The software comprises identifying one or more fields in the form, and automatically supplying information corresponding to the one or more identified fields without intervention by the user.

In yet another respect, the invention is a system for automated form completion for a user of a computer. The system comprises a field identifier module capable of identifying one or more fields in a form and a field completer module capable of supplying information corresponding to the one or more identified fields without intervention by the user.

In comparison to known prior art, certain embodiments of the invention are capable of achieving certain advantages, including some or all of the following: (1) saving user time; (2) saving user frustration; (3) providing greater flexibility to users in deciding how much information should be automatically supplied; and (4) universal applicability to all forms, not just certain “participating” ones. Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

FIG. 1 is a flow chart in accordance with a manner in which an embodiment of the invention may be practiced; and

FIG. 2 is a system diagram in accordance with an embodiment of the invention discussed in FIG. 1.

### DETAILED DESCRIPTION OF A PREFERRED EMBODIMENT

For simplicity and illustrative purposes, the principles of the invention are described by referring mainly to an exemplary embodiment thereof, particularly with references to a system to automatically complete electronic forms (“e-forms”). However, one of ordinary skill in the art would readily recognize that the same principles are equally applicable to, and can be implemented in, a system capable of completing any computer readable form, and that any such variations are within the scope of the invention.

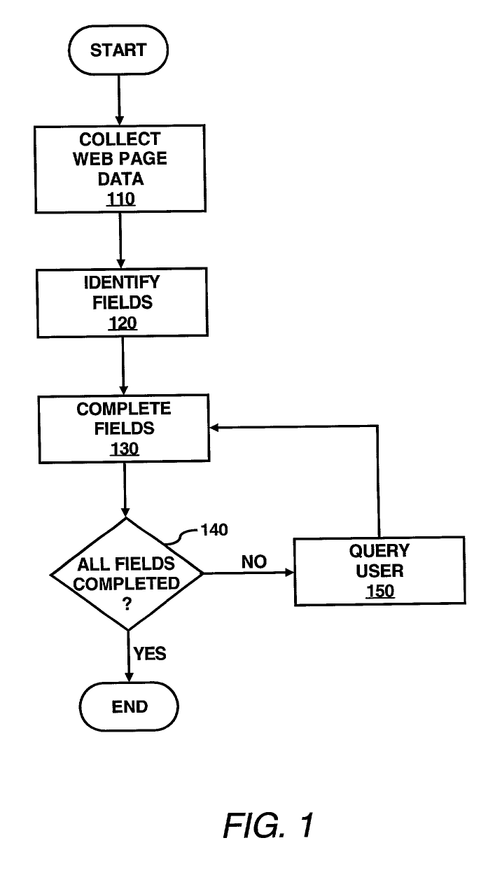

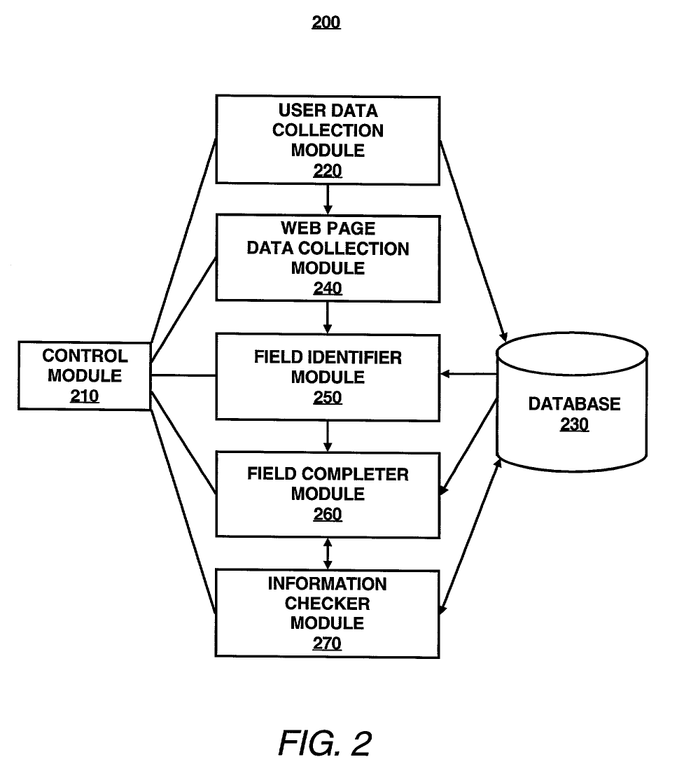

Although e-forms and Web page registration forms are described in this invention, it is to be understood that the invention is not limited to e-forms and Web page registration forms, but rather, the invention may be configured to complete any form capable of being read by a computer. Accordingly, the Web page registration form described is for illustrative purposes only and thus not meant to limit the invention in any respect. Additionally, the invention can be practiced in a variety of forms, three of which are described below in the detailed description of FIG. 1 and again in the detailed description of FIG. 2.

FIG. 1 is a flow chart of an auto-completing method 100 in accordance with a manner in which an embodiment of the invention may be practiced. Although not depicted in FIG. 1, prior to initiating the method 100, a database 230, as shown in FIG. 2, may be generated. The data stored within the database 230 may include personal information entered by a user.

The personal information may correspond to fields typically included in Web page registration forms. Examples of typical fields may include the following: name, birthday, address, phone number, etc. The data stored within the database 230 may further include user preference information. The user preference information may include the following options: to complete all fields, to only complete required fields (e.g., fields in which a required status substantially equals “yes”), etc. Additionally, the user preference data may include the option to utilize different user profiles. For example, multiple users of a single computer may utilize respective user profiles. In a second example, a user may utilize a work profile, a home profile, etc.

The auto-completing method 100 may be initiated upon locating an e-form within a Web browser e.g., NETSCAPE NAVIGATOR, MICROSOFT INTERNET EXPLORER, etc. In step 110, the auto-completing method 100 may be configured to gather information about the active Web page displayed by the Web browser. In a preferred embodiment, the auto-completing method 100 may be configured to gather information by accessing the source code or HTML (hypertext markup language) version of the active Web page. The Web page data may include mark-up tags, text elements from within mark-up tags, additional computer readable text and the respective order of each text element.

In step 120, the auto-completing method 100 may be configured to reference the Web page data and the database 230. The Web page data may be parsed to generate a table of fields. Fields may be determined based upon the respective mark-up tags which define how each text element is displayed. In general, determining which text elements constitute fields may depend upon the following factors: associated mark-up tags, proximity to predetermined mark-up tags, length of text within a text element, width of character, etc. The table of fields may include an entry for each field determined from the Web page data. Each entry in the table of fields may include a field and the respective order for the field.

Additionally, in step 120, a list of alternative spellings may be generated by spell checking each field in the table of fields. A list of synonyms may be generated for each field and any associated alternative spellings in the table of fields. Any associated synonyms for each field and any associated alternative spellings may also be stored to the respective entry in the table of fields.

Furthermore, in step 120, the table of fields may be compared against the database 230. Each field in the database 230 may be compared against each entry in the table of fields (e.g., field and associated alternative spelling, and synonym). For example, a parser may parse the table of fields and the database and a comparison algorithm may be applied to the parser output. Each time a single substantial match for a field in the database 230 is found, the respective entry in the table of fields may be marked as an identified field (an identified status (yes/no) may be toggled to “yes”). If more than one field from the database 230 are found to match an entry in the table of fields, the identified status may be left as “no”. Thus, for the purpose of this disclosure, an unidentified field is a field in which either no field from the database 230 or more than one field from the database 230 is found to match an entry in the table of fields.

Moreover, in step 120, it may be determined if each entry in the table of fields is required based on the Web page data. For example, if the word ‘required’ is identified directly adjacent to or below an entry in the table of fields, a required status (yes/no) of the entry in the table of fields may be marked as “yes”. In a second example, if an asterisk is identified directly adjacent to an identified field and an asterisk along with the word ‘required’ is identified near the bottom of the form, the required status (yes/no) of the entry in the table of fields may be marked as “yes”.

In step 130, the auto-completing method 100 may be configured to reference the table of fields and the database 230 to complete the identified fields based on the user preferences. The auto-completing method 100 may be configured to navigate the field entry boxes by generating tab key signals in response to the respective order of the identified fields. Corresponding data for each of the identified fields may be entered within the respective field entry box. Thus, data may be entered as 1st field data; tab; 2nd field data; tab; 3rd field data; tab; etc. In response to entering data within the respective field entry box, a corresponding completed status (yes/no) in the table of fields may be toggled to “yes”.

In step 140, the auto-completing method 100 may be configured to determine if all fields have been completed. In the event the completed status is substantially equal to “no” for at least one entry in the table of fields, the auto-completing method 100 may proceed to step 150. If it is determined that the completed status is substantially equal to “yes” for each entry in the table of fields, the auto-completing method 100 may terminate to allow the user to review the auto-completed entries and submit the Web site registration page.

In step 150, the auto-completing method 100 may be configured to open a dialog window to query the user. The dialog window may be configured to display the unidentified field from the entry in the table of fields and suggestions (e.g., associated synonym and alternative spellings), each in a respective text box. The dialog box may be configured to provide the user the capability to select one of the provided suggestions or manually enter a correction. The dialog window may further be configured to display a plurality of user selectable icons e.g., ignore, ignore all, add, change, change all, autocorrect, options, undo, cancel, etc. Selecting an icon may initiate an appropriate response. For example, in response to selecting ‘ignore’, the completed status (yes/no) may be toggled to “yes” in a respective entry in the table of fields. Information entered into the dialog window may be stored to the database 230. Following the step 150, the auto-completing method 100 may return to step 130.

In a second embodiment, in step 110, the auto-completing method 100 may, in response to an inability to access a source code, capture an image of the active Web page. The auto-completing method 100 of the second embodiment is similar to the auto-completing method 100 described above and thus only those features which are reasonably necessary for a complete understanding of the second embodiment are described below.

The auto-completing method 100 may further be configured to apply an optical character recognition (“OCR”) algorithm to the captured graphical image in step 110. The auto-completing method 100 may further be configured to generate Web page data in response to performing OCR on the graphical image. The Web page data may include: computer readable text, corresponding (x,y) coordinate information for identified text, and (x,y) coordinate information for identified field entry box(es). The (x,y) coordinate information for identified field entry box(es) may be determined by performing an edge analysis algorithm on the graphical image.

In step 120, the auto-completing method 100 may be configured to reference the Web page data and the database 230. The Web page data may be parsed to generate a table of fields. In addition to those items described in the first embodiment, the table of fields in the second embodiment may further include corresponding (x,y) coordinate information for identified text, and (x,y) coordinate information for identified field entry box(es).

In step 130, the auto-completing method 100 may be configured to reference the table of fields and the database 230 to complete the e identified fields based on the user preferences. The auto-completing method 100 may be configured to navigate the field entry boxes by generating click events at the respective (x,y) coordinates' of field entry boxes associated with identified fields. Corresponding data for each of the identified fields may be entered within the respective field entry box. In response to entering data within the respective field entry box, a corresponding completed status (yes/no) in the table of fields may be toggled to “yes”.

In a third embodiment, in step 110, the auto-completing method 100 may be configured to identify the “submit” icon (or “done”, “continue” or something similar) within the registration page. The auto-completing method 100 of the third embodiment is similar to the second embodiment of the auto-completing method 100 described above and thus only those features which are reasonably necessary for a complete understanding of the alternative embodiment are described below.

In step 120, the auto-completing method 100 may be further configured to identify the respective (x,y) coordinates of the “submit” or similar icon. The respective (x,y) coordinates of the ‘submit’ icon may also be stored within the table of fields.

In step 140, the auto-completing method 100 may be configured to initiate a click event at the (x,y) coordinates of the ‘submit’ icon in response to the completed status of all identified fields substantially equal to “yes”.

FIG. 2 is a system diagram in accordance with an embodiment of the invention discussed in FIG. 1. The following description of FIG. 2 will be made with particular reference to the system described in FIG. 1. Accordingly, as depicted in FIG. 2, an auto-completing system 200 including a control module 210 may be configured to utilize a user data collection module 220 to gather information to be stored in a database 230. During installation of the auto-completing system 200, the control module 210 may be configured to run the user data collection module 220 to collect personal information from a user. Although FIG. 2 depicts the control module 210, it is well known to those having ordinary skill in the art that the control module 210 is optional and that the control functions of the control module 210 may be subsumed within the remaining modules without departing from the scope of the invention.

In operation, the auto-completing system 200 may be initiated from a Web browser (not shown). The control module 210 may, in response to initiation, initiate a Web page data collection module 240. The Web page data collection module 240 may be configured to perform the functions described in step 110. In this respect, the Web page data collection module 240 may be configured to gather information from the active Web page.

In a preferred embodiment, the Web page data collection module 240 may be configured to access source code information for the registration page to gather information. The Web page data collection module 240 may further be configured to forward the Web page data to a field identifier module 250.

The field identifier module 250 may be configured to perform the functions described in step 120. In this respect, the field identifier module 250 may be configured to reference the Web page data and the database 230. The field identifier module 250 may further be configured with a parser to generate a table of fields based on the parsed Web page data. The field identifier module 250 may further be configured with a spell checker, a thesaurus and a comparison algorithm. The field identifier module 250 may be further configured to determine if each of the identified fields is required based on the Web page data. The field identifier module 250 may be further configured to set a completed status (yes/no) to “no” for each of the identified fields. The field identifier module 250 may further be configured to forward the respective order, identity, completed status (yes/no) and required status (yes/no) for each located field to a field completer module 260.

The field completer module 260 may be configured to perform the functions described in step 130 and step 140. In this respect, the field completer module 260 may be configured to complete the fields based on the following information: the field identity, respective order of each field, and user preference. In the event the field identifier module 250 is not able to identify a field, the field completer module 260 may forward the table of fields to an information checker module 270. The field completer module 260 may further be configured to receive and utilize the table of fields forwarded by the information checker module 270 to complete field entry.

In response to receiving the table of fields, the information checker module 270 may be initiated. The information checker module 270 may be configured to perform the functions described in step 150. In this respect, the field completer module 260 may comprise a user interface and associated logic to query the user regarding unidentified fields and gather additional personal information as required. The information checker module 270 may be further configured to forward the information to the field completer module 260 and store the additional information to the database 230.

In a second embodiment, the Web page data collection module 240 may, in response to an inability to access a source code, capture an image of the active Web page. The auto-completing system 200 of the second embodiment is similar to the auto-completing system 200 described above and thus only those features which are reasonably necessary for a complete understanding of the second embodiment are described below. One such difference is that the Web page data collection module 240 includes an OCR capability.

The Web page data collection module 240 may be configured to perform OCR on the captured graphical image. The Web page data collection module 240 may further be configured to forward the OCR data to the field identifier module 250. The OCR data may include computer readable text and (x,y) coordinates.

The field completer module 260 may be configured to complete the fields based on the following information: the (x,y) coordinates of the fields, field identity, and user preference.

In a third embodiment, the field identifier module 250 may be configured to identify the “submit” or similar icon within the registration page. The auto-completing system 200 of the third embodiment is similar to the second embodiment of the auto-completing system 200 described above and thus only those features which are reasonably necessary for a complete understanding of the alternative embodiment are described below.

The field identifier module 250 may be further configured to identify the respective (x,y) coordinates of the ‘submit’ icon. The field identifier module 250 may be further configured to store the respective (x,y) coordinates of the ‘submit’ icon within the table of fields.

The field completer module 260 may be configured to initiate a click event at the (x,y) coordinates of the ‘submit’ icon in response to the completed status of all identified fields substantially equal to “yes”.

The auto-completing system 200 can exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for automated form completion for a user of a computer, the method comprising the steps of:
identifying one or more fields in a form; and
automatically supplying information corresponding to the one or more identified fields without intervention by the user.

2. The method of claim 1, further comprising the steps of:
determining the correct spelling of one or more words associated with the one or more fields; and
determining a synonym for one or more words associated with the one or more fields.

3. The method of claim 2, further comprising the step of:
determining the identity of the one or more fields based on the respective similarity of each field to a previously stored field.

4. The method of claim 3, wherein the form is a Web page and the method further comprises:
reading a source code of the Web page; and
determining fields based on associated mark-up tags.

5. The method of claim 3, wherein the form is a Web page and the method further comprises:
capturing an image of the Web page;
identifying text by performing OCR on the image;
identifying field entry box(es) by performing edge analyses on the image; and
determining coordinates of the identified fields entry box(es).

6. The method of claim 1, further comprising the step of:
prompting the user to accept the automatically supplied information.

7. The method of claim 1, further comprising the step of: enabling the user to enter information for fields unidentified in the form.

8. A computer readable medium on which is embedded computer software capable of automatically completing a form for a user of a computer, the software comprising:
identifying one or more fields in the form; and
automatically supplying information corresponding to the one or more identified fields without intervention by the user.

9. The computer readable medium of claim 8, further comprising the step of:
determining the correct spelling of one or more words associated with the one or more fields; and
determining a synonym for one or more words associated with the one or more fields.

10. The computer readable medium of claim 9, further comprising the step of:
determining the identity of the one or more fields based on the respective similarity of each field to a previously stored field.

11. The computer readable medium of claim 10, where in the form is a Web page and the method further comprises:
reading a source code of the Web page; and
determining fields based on associated mark-up tags.

12. The computer readable medium of claim 10, wherein the form is a Web page and the method further comprises:
capturing an image of the Web page;
identifying text by performing OCR on the image;
identifying field entry box(es) by performing edge analyses on the image; and
determining coordinates of the identified fields entry box(es).

13. The computer readable medium of claim 8, further comprising the step of:
prompting the user to accept the automatically supplied information.

14. The computer readable medium of claim 8, further comprising the step of:
enabling the user to enter information for fields unidentified in the form.

15. A system for automated form completion for a user of a computer comprising:
a field identifier module capable of identifying one or more fields in a form; and
a field completer module capable of supplying information corresponding to the one or more identified fields without intervention by the user.

16. The system of claim 15, wherein the field identifier module comprises:
a parser configured to generate a table of fields;
a spell checker configured to store alternative spellings of fields;
a thesaurus configured to store synonyms of fields; and
a comparison algorithm connected to the parser, the spell checker and the thesaurus, the comparison algorithm configured to determine the identity of each field based on the respective similarity of each field to one or more fields in the database.

17. The system of claim 16, further comprising:
a data collector module configured to read the form; and
an information checker comprising:
a user interface configured to display an unidentified field and user selectable options to the user;
associated logic configured to determine the identity of the unidentified field in response to a selection; and
the information checker is further configured to store the determined identity of the unidentified field to the database.

18. The system of claim 17, wherein the form is an e-form readable in a Web browser.

19. The system of claim 18, wherein the data collector module is configured to access the source code of the e-form.

20. The system of claim 18, wherein the data collector module is configured to OCR a captured image of the e-form.
